(19) United States
(12) Patent Application Publication
(10) Pub. No.: US 2026/0008138 A1
(43) Pub. Date: Jan. 8, 2026

(54) DEVICE FOR MACHINING LINER WELDING BEAD OF HYDROGEN TANK

(71) Applicants: HYUNDAI MOTOR COMPANY, Seoul (KR); Kia Corporation, Seoul (KR)

(72) Inventors: Kyuyoung LEE, Hwaseong-si (KR); Youngsil WOO, Hwaseong-si (KR)

(21) Appl. No.: 18/948,966

(22) Filed: Nov. 15, 2024

(30) Foreign Application Priority Data
Jul. 3, 2024 (KR) 10-2024-0087266

(51) Int. Cl. B23K 37/08

(52) U.S. Cl. CPC B23K 37/08

(57) ABSTRACT

A device for machining a hydrogen tank is configured to cut a welding bead disposed at a liner of the hydrogen tank. The device includes i) a jig frame, ii) a liner mount that rotatably supports the liner and applies a rotational force to the liner, iii) a liner outer support that supports an outer circumferential surface of the liner, iv) a bead cutter installed on the jig frame to be movable forward and backward by driving a cutter driver to cut the welding bead, v) a reaction force detection sensor coupled to the bead cutter to detect a reaction force applied to the bead cutter, and vi) a controller configured to control a forward-backward movement distance of the bead cutter by applying a set driving control signal according to a detection signal of the reaction force detection sensor to the cutter driver.

### CROSS-REFERENCE TO RELATED APPLICATION

This application claims priority to and the benefit of Korean Patent Application No. 10-2024-0087266, filed in the Korean Intellectual Property Office on July 3, 2024, the entire contents of which are incorporated herein by reference.

### TECHNICAL FIELD

The disclosure relates to a hydrogen tank manufacturing system, and more particularly, to a device for machining a liner welding bead of a hydrogen tank, configured to cut welding beads of liner parts during a process of welding liner parts of a hydrogen tank.

### BACKGROUND

The development and demand for eco-friendly vehicles have increased due to the strengthening of carbon dioxide emission standards. Eco-friendly vehicles can include, for example, hybrid vehicles, electric vehicles, hybrid electric vehicles, hydrogen electric vehicles (also commonly referred to as ‘hydrogen-powered vehicles’ by those skilled in the art).

In some cases, a hydrogen tank may be mounted on the body of a hydrogen electric vehicle. For example, the hydrogen tank may include a plastic liner (or liner tank) and a carbon fiber composite as an outer skin covering an outer surface of the liner.

In some cases, the liner may be manufactured by a process of injection-molding a plurality of liner parts, a process of melt-bonding (e.g., welding) open end portions of the liner parts, etc. In the liner welding process, the open end portions (or bonding end portions) of the liner parts that are opposed to each other or overlap each other may be welded by an infrared thermal welding method, an induction heating method, a laser welding method, etc.

In the liner welding process, a welding bead, which is a melting by-product that protrudes from the outer surface of the liner, may be formed at the welded portions of the liner parts. In some cases, in order to perform a subsequent process of wrapping the outer surface of the liner to which the liner parts are welded with a carbon fiber composite, a process of removing the welding bead may be performed.

In some cases, cutting the welding bead may be performed manually, where a cutting deviation of the welding bead may occur depending on a welding state of the liner and the skill of a worker.

For example, if the open end portions of the liner parts are misaligned and welded or a forward movement distance of the bead cutter is excessive, the welding bead may be cut excessively beyond a set cutting amount. Such excessive cutting of the welding bead may cause poor welding of the liner. In other words, a liner with excessive welding bead cutting may not secure the strength, durability, and airtightness of the welding portion.

### SUMMARY

The present disclosure describes a device for machining a liner welding bead of a hydrogen tank capable of minimizing a cutting deviation of a welding bead according to a welding state of the liner, a rotation state of the liner, and a forward movement distance of a cutter.

According to one aspect of the subject matter described in this application, a device for machining a hydrogen tank is configured to cut a welding bead disposed at a liner of the hydrogen tank. The device includes a jig frame, a liner mount disposed at the jig frame and configured to rotatably support the liner and to apply a rotational force to the liner, a liner outer support disposed at the jig frame and configured to support an outer circumferential surface of the liner, a bead cutter disposed at the jig frame and configured to move forward and backward along the liner and to cut the welding bead, a cutter driver configured to move the bead cutter forward and backward along the liner, a reaction force detection sensor coupled to the bead cutter and configured to detect a reaction force applied to the bead cutter, and a controller configured to control a forward-backward movement distance of the bead cutter based on applying, the cutter driver, a set driving control signal according to a detection signal of the reaction force detection sensor.

Implementations according to this aspect can include one or more of the following features. For example, the device can further include a liner inner support disposed at the liner mount and configured to support an inner circumferential surface of the liner by injecting air at a set pressure into an inside of the liner. In some implementations, the liner mount can include a main mounting portion disposed at a front portion of the jig frame and configured to support a front nozzle provided at a first side of the liner, a sub-mounting portion disposed at a rear of the jig frame and configured to support a rear nozzle provided at a second side of the liner, a rotational driver disposed at the main mounting portion and configured to apply the rotational force to the liner, a liner chucking portion connected to the rotational driver and rotatably disposed at the main mounting portion and configured to be coupled to the front nozzle, a liner docking portion disposed at the sub-mounting portion and configured to move in a front-rear direction relative to the rear of the jig frame to thereby support the rear nozzle, and a docking driver configured to move the liner docking portion in the front-rear direction relative to the rear of the jig frame.

In some implementations, the liner outer support can include an inner ring configured to surround the outer circumferential surface of the liner and to rotate with the liner, an outer bracket fixed to a set position of the jig frame, wherein the inner ring is disposed at an inner side of the outer bracket, and a plurality of bearing members disposed at the outer bracket and configured to support the inner ring. In some examples, each of the plurality of bearing members can include a bearing rod movably coupled to the outer bracket and configured to move toward and away from an outer circumferential surface of the inner ring, and a ball rotatably disposed at the bearing rod and configured be in contact with the outer circumferential surface of the inner ring based on rotation of the liner.

In some examples, the inner ring can include a ball race that is a groove defined along the outer circumferential surface of the inner ring and configured to contact with the balls. In some examples, the outer bracket can include a first portion fixed to the jig frame, and a second portion hingedly connected to the first portion through a hinge pin.

In some implementations, the device can include a shuttle block disposed at the jig frame and configured to move in a front-rear direction, a shuttle driver configured to move the shuttle block in the front-rear direction, and a cutter support block disposed at the shuttle block and coupled to the bead cutter, the cutter support block being configured to move, by the cutter driver, in a left-right direction transverse to the front-rear direction. In some examples, the device can include a stopper roller rotatably disposed at the cutter support block and configured to rotate based on being in contact with the outer circumferential surface of the liner. In some implementations, the device can include a mounting block coupled to the cutter support block, where the bead cutter is fixed to the mounting block, and the reaction force detection sensor is fixed to the mounting block and coupled to the bead cutter.

In some examples, the liner inner support can include an air blower configured to supply air at the set pressure to the inside of the liner through a front nozzle disposed at a first side of the liner. In some examples, the liner inner support further can include a pressure sensor configured to detect an internal pressure of the liner and to output a detection signal to the controller. In some examples, the liner inner support can further include an air valve, where the controller is configured to control a valve opening amount of the air valve based on the detection signal of the pressure sensor.

In some implementations, the controller is configured to determine whether a reaction force value of the bead cutter obtained from the reaction force detection sensor exceeds a set reference value, and apply a reverse driving control signal to the cutter driver based on determining that the reaction force value of the bead cutter exceeds the set reference value. In some examples, the controller is configured to apply a forward driving control signal to the cutter driver based on determining that the reaction force value of the bead cutter is less than or equal to the set reference value. In some examples, the controller is configured to adjust the valve opening amount of the air valve based on an internal pressure value of the liner obtained from the pressure sensor.

In some implementations, the liner inner support can further include a solenoid valve configured to disposed at a rear nozzle of the liner, the rear nozzle being disposed at a second side of the liner, where the controller is configured to open and close the solenoid valve based on an internal pressure value of the liner obtained from the pressure sensor.

In some implementations, the cutting deviation of the welding bead according to the welding state of the liner, the rotation state of the liner, and the forward movement distance of the bead cutter can be minimized, thereby reducing the welding defect of the liner.

### BRIEF DESCRIPTION OF THE DRAWINGS

The one or more implementations of the present specification can be better understood with reference to the following description in conjunction with the accompanying drawings in which similar reference numerals designate the same or functionally similar elements.

FIG. 1 is a perspective view illustrating an example of a device for machining a liner welding bead of a hydrogen tank.

FIG. 2 is a side view illustrating the device for machining the liner welding bead.

FIG. 3 is a cross-sectional view illustrating an example of a liner applied to the device for machining the liner welding bead.

FIG. 4 is a perspective view illustrating an example of a liner outer support applied to the device for machining the liner welding bead.

FIG. 5 is an exploded perspective view illustrating the liner outer support.

FIG. 6 is a front view illustrating the liner outer support.

FIG. 7 is a schematic view illustrating an example of a liner inner support applied to the device for machining the liner welding bead.

FIG. 8 is a view illustrating an example of a mounting structure of a bead cutter applied to the device for machining the liner welding bead.

FIGS. 9 and 10 are flowcharts illustrating an example control process of a device for machining a liner welding bead of a hydrogen tank.

FIG. 11 is a drawing illustrating an example of a liner inner support applied to a device for machining a liner welding bead of a hydrogen tank.

### DETAILED DESCRIPTION

In the present disclosure, the term “vehicle”, “vehicular”, “automobile”, or other similar term as used herein can generally refer to passenger vehicles including sports cars, sports utility vehicles (SUV), buses, trucks, passenger automobiles including various commercial vehicles, include hybrid vehicles, electric vehicles, hybrid electric vehicles, hydrogen-powered vehicles, purpose built vehicles (PBVs) based on electric vehicles, light commercial vehicles (LCVs) based on hydrogen-powered vehicles, and other alternative fuel vehicles (e.g. fuels derived from resources other than petroleum).

Hereinafter, one or more implementations of the disclosure are described in detail with reference to the accompanying drawings.

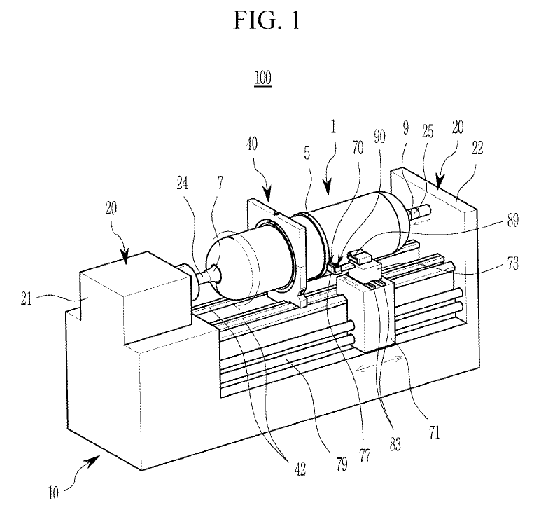

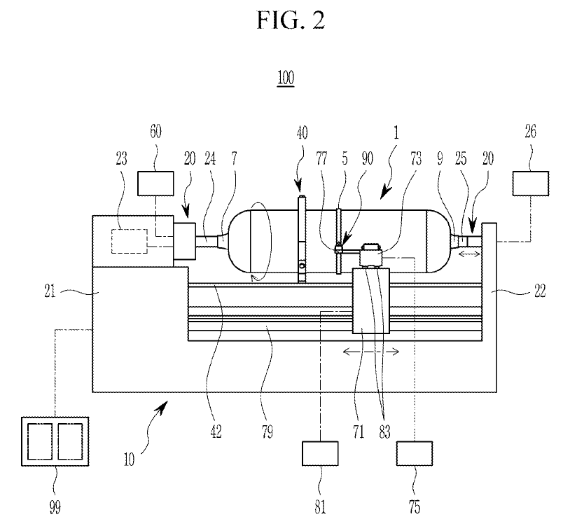

FIG. 1 is a perspective view illustrating an example of a device for machining a liner welding bead of a hydrogen tank, and FIG. 2 is a side view illustrating a device for machining a liner welding bead of a hydrogen tank.

Referring to FIGS. 1 and 2, a device 100 for machining a liner welding bead of a hydrogen tank can be applied to a process of manufacturing a hydrogen tank that can be mounted on a body of a hydrogen electric vehicle.

Furthermore, the device 100 can be applied to a process of manufacturing a liner 1 configured inside the hydrogen tank.

For example, the liner 1 is a tank-shaped inner skin that configures the hydrogen tank and can be formed to have a circular closed cross-section. For instance, the liner 1 can include a cylinder. In some examples, the liner 1 can be made of a plastic material. In some examples, a carbon fiber composite material can be provided as an outer skin on an outer surface of the liner 1.

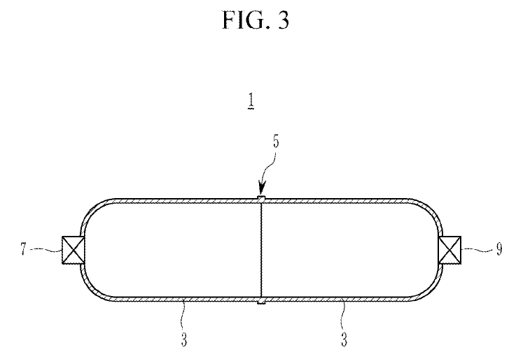

In some implementations, as shown in FIG. 3, the liner 1 can include a plurality of liner parts 3 formed by an injection molding method.

In some examples, open end portions of the liner parts 3 can be welded by an infrared thermal welding method, an induction heating method, a laser welding method, etc., in a state in which they are facing each other or overlapping each other in the liner welding process. Accordingly, a welding bead 5 protruding from an outer circumferential surface of the liner parts 3 is formed at a welding portion of the liner parts 3.

Furthermore, the liner 1 as described above includes a front nozzle 7 provided on one side in a longitudinal direction and a rear nozzle 9 provided on the other side. In an example, the front nozzle 7 can be a hydrogen gas injection portion through which hydrogen gas is injected into the inside of the liner 1. Also, the rear nozzle 9 can be a hydrogen gas discharge portion through which hydrogen gas is externally discharged from the inside of the liner 1.

In some implementations, it is described that the liner 1 is applied to a hydrogen tank that can be installed in a hydrogen electric vehicle. However, without being limited thereto, the technical idea of the disclosure can be applied to a liner of a hydrogen tank mounted on various mobile devices and power generation facilities, etc.

In this specification, a reference direction for describing the following components can be set as a front-rear direction based on a longitudinal direction of the liner 1, a left-right direction and an up-down direction intersecting the front-rear direction.

Furthermore, in this specification, an ‘upper end portion, ‘upper portion, ‘upper end or ‘upper surface’ of a component indicates an end portion, portion, end, or surface of the component that is relatively above in the drawing, and a ‘lower end portion, ‘lower portion, ‘lower end or ‘lower surface’ of a component indicates an end portion, portion, end, or surface of the component that is relatively below in the drawing.

Furthermore, in this specification, an end (e.g., one end or the other end) of a component indicates an end of the component in any one direction, and an end portion of a component (e.g., one end portion or the other end portion) indicates a certain portion of the component including the end.

The device 100 is configured to automatically cut (or remove) the welding bead 5 of the liner 1 instead of manually in the liner welding process.

The device 100 automatically moves the cutter forward and backward according to a reaction force value applied to a cutter for cutting the welding bead 5 of the liner 1 and provides a structure capable of cutting the welding bead 5.

Furthermore, the device 100 can provide a structure capable of minimizing a cutting deviation of the welding bead 5 according to a welding state of the liner 1, a rotation state of the liner 1, and a forward movement distance of the cutter and reducing a welding defect of the liner 1.

In some implementations, the device 100 includes a jig frame 10, a liner mount 20, a liner outer support 40, a liner inner support 60, a bead cutter 70, a reaction force detection sensor 90, and a controller 99.

In some implementations, the jig frame 10 can be fixed to a floor surface of a process workplace in a static manner or can be provided to be movable to a set position on the floor surface.

The jig frame 10 is configured to mount various components to be described below. The jig frame 10 can include one frame or two or more partitioned frames.

The jig frame 10 can include various accessory components, such as a bracket, a bar, a rod, a plate, a housing, a case, a block, a partition, a rib, etc. which can be configured to support each component.

However, since the aforementioned various accessory components are configured to mount each component to be described below on the jig frame 10, in some implementations, the aforementioned various accessory components are collectively referred to as the jig frame 10, except for exceptional cases.

In some implementations, the liner mount 20 is configured to rotatably mount the liner 1 on the jig frame 10. In addition, the liner mount 20 is configured to apply a set rotational force to the liner 1. The liner mount 20 is installed on the jig frame 10.

This liner mount 20 includes a main mounting portion 21, a sub-mounting portion 22, a rotational driver 23, a liner chucking portion 24, and a liner docking portion 25.

The main mounting portion 21 is disposed at a front portion of the jig frame 10 to support the front nozzle 7 of the liner 1. The sub-mounting portion 22 is disposed at a rear of the jig frame 10 to support the rear nozzle 9 of the liner 1.

The rotational driver 23 is installed at the main mounting portion 21 to apply a set rotational force to the liner 1. In an example, the rotational driver 23 includes a servo motor installed at the main mounting portion 21. The servo motor can be provided as a motor capable of servo control in a rotation speed and rotation direction.

The liner chucking portion 24 is rotatably installed on the main mounting portion 21 to be chuck-coupled to the front nozzle 7 of the liner 1 and is operatively connected to the rotational driver 23.

In addition, the liner docking portion 25 is configured to support the rear nozzle 9 of the liner 1. The liner docking portion 25 is installed to be movable on the sub-mounting portion 22 in the front-rear direction by the driving of a docking driver 26.

In some examples, the docking driver 26 is operatively connected to the liner docking portion 25. The docking driver 26 can include an operating cylinder installed on the sub-mounting portion 22, in an example. In another example, the docking driver 26 can include an actuator that converts a rotational motion of the motor into a linear motion through a power converter.

In some implementations, the liner outer support 40 is mounted on the liner mount 20 to support (or regulate) the outer circumferential surface of the rotating liner 1. The liner outer support 40 is installed on the jig frame 10.

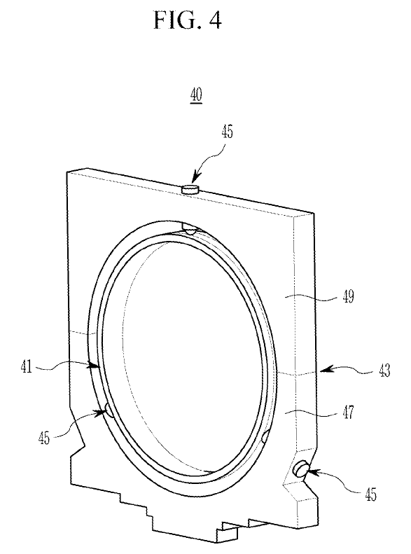

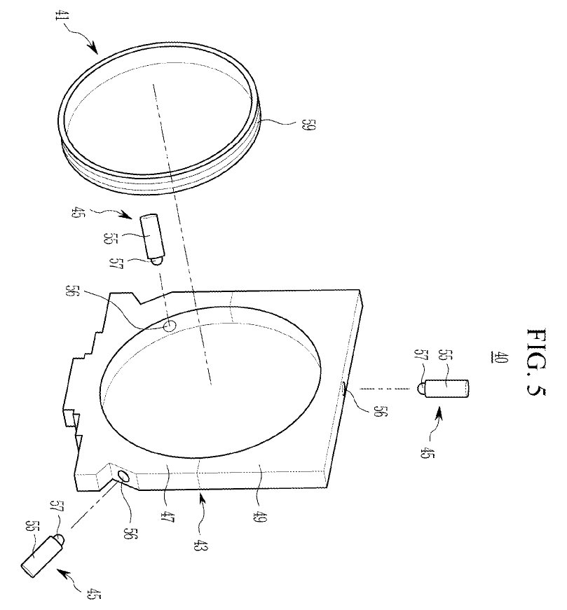

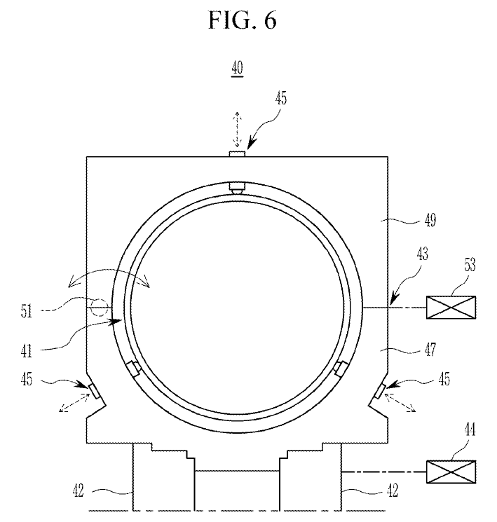

FIG. 4 is a perspective view illustrating a liner outer support applied to a device for machining a liner welding bead of a hydrogen tank, FIG. 5 is an exploded perspective view illustrating a liner outer support applied to a device for machining a liner welding bead of a hydrogen tank k, and FIG. 6 is a front view illustrating a liner outer support applied to a device for machining a liner welding bead of a hydrogen tank.

Referring to FIGS. 1 and 2 and FIGS. 4 to 6, the liner outer support 40 includes an inner ring 41, an outer bracket 43, and a plurality of bearing members 45.

The inner ring 41 is provided in a circular ring shape that surrounds the outer circumferential surface of the liner 1 to rotate together with the liner 1.

The inner ring 41 can include an inner circumferential surface and an outer circumferential surface and can be fitted and fixed to the outer circumferential surface of the liner 1 in the longitudinal direction of the liner 1 through the inner circumferential surface. The inner ring 41 can be manufactured to fit an outer diameter of the liner 1 and can be manufactured in various sizes according to an outer diameter of the liner 1.

Since the inner ring 41 is manufactured in the shape of a perfect circle and rotates together with the liner 1, the inner ring 41 serves to correct the out of roundness of the liner 1.

The outer bracket 43 is fixed to a set position of the jig frame 10 at a position corresponding to the inner ring 41 with the inner ring 41 placed inside thereof. The set position here can be defined as a position corresponding to the inner ring 41. That is, the position of the outer bracket 43 can vary depending on the position of the inner ring 41.

In an example, an edge shape of the outer bracket 43 can be approximately a square shape. A circular hole having a diameter larger than the outer diameter of the inner ring 41 is formed in the outer bracket 43.

The outer bracket 43 can be fixed to a pair of fixed rails 42 disposed in the front-rear direction of the jig frame 10. In some examples, the outer bracket 43 and the fixed rails 42 can be fastened by a fastening member 44 including a combination of bolts and nuts.

Furthermore, the outer bracket 43 includes a first portion 47 and a second portion 49. The first portion 47 and the second portion 49 can be provided in a shape in which the outer bracket 43 is divided into two equal parts.

That is, each of the first portion 47 and the second portion 49 forms a semicircle with a circular hole divided into two equal parts. The first portion 47 and the second portion 49 can join each other to form the circular hole described above.

In some examples, the first portion 47 can be fixed to the fixed rails 42 by the fastening member 44. In addition, the second portion 49 can be rotatably coupled to the first portion 47 through a hinge pin 51. The first portion 47 and the second portion 49 can be locked and unlocked by a locking member 53 that is obvious to a person skilled in the art, for example.

Also, the bearing members 45 are configured to support the outer circumferential surface of the inner ring 41. The bearing members 45 are installed in the outer bracket 43. Each of the bearing members 45 includes a bearing rod 55 and a ball 57.

The bearing rod 55 is disposed radially on the outer bracket 43 based on the center of the circular hole of the outer bracket 43. The bearing rod 55 can be disposed radially by penetrating through an inner circumferential surface of the hole on an outer surface of the outer bracket 43.

The bearing rod 55 is movably coupled to the outer bracket 43 in a direction toward or away from the outer circumferential surface of the inner ring 41 depending on the outer diameter size of the inner ring 41.

In an example, the bearing rod 55 can be screw-coupled to a through-hole 56 connected from the outer surface of the outer bracket 43 to the inner circumferential surface of the circular hole. Accordingly, the bearing rod 55 can be screw-coupled to the through-hole 56 and can move in a direction toward or away from the outer circumferential surface of the inner ring 41 as it rotates.

In addition, the ball 57 is rotatably mounted on the bearing rod 55 and comes into rolling contact with the outer circumferential surface of the inner ring 41 in a rotational direction of the liner 1. In some examples, the inner ring 41 includes a ball race 59 in the form of a groove formed on the outer circumferential surface in the rotational direction of the liner 1 so that the ball 57 comes into rolling contact.

Referring to FIG. 2, in some implementations, the liner inner support 60 is configured to inject air at a set pressure into the inside of the liner 1 to support the inner circumferential surface of the liner 1 with the pressure of air. The liner inner support 60 is installed in the main mounting portion 21 of the liner mount 20.

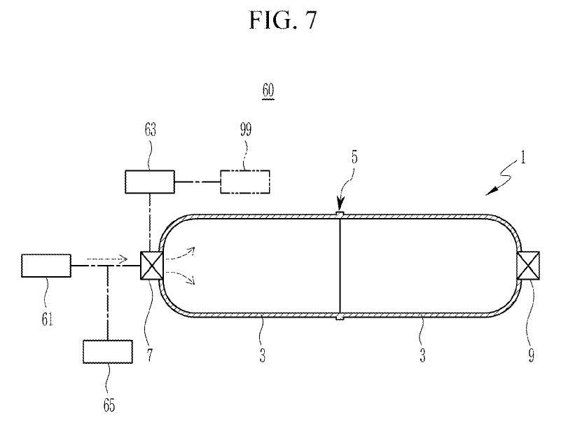

FIG. 7 is a schematic view illustrating a liner inner support applied to a device for machining a liner welding bead of a hydrogen tank.

Referring to FIG. 7, the liner inner support 60 includes an air blower 61, a pressure sensor 63, and an air valve 65.

The air blower 61 is configured to supply (or inject) air into the inside of the liner 1 through the front nozzle 7 of the liner 1.

The pressure sensor 63 is configured to detect internal pressure (e.g., air pressure) of the liner 1. The pressure sensor 63 can be installed, for example, in a connector connecting the air blower 61 and the front nozzle 7.

In addition, the air valve 65 is configured to control a flow rate of air injected into the inside of the liner 1 through the air blower 61. The air valve 65 can include, for example, an electronic valve having a valve opening amount that can be controlled by an electric signal. The valve opening amount of the air valve 65 can be adjusted (for example, vary) according to an internal pressure value of the liner 1 detected by the pressure sensor 63.

In some examples, the air valve 65 is configured to be opened to a set reference opening amount OP to supply air of a set flow rate to the inside of the liner 1.

The air valve 65 can be opened to a first opening amount OP1 smaller than the reference opening amount OP according to a detection signal of the pressure sensor 63 to reduce a flow rate of air supplied to the inside of the liner 1. In addition, the air valve 65 can be opened to a second opening amount OP2 larger than the reference opening amount OP according to a detection signal of the pressure sensor 63 to increase the flow rate of air supplied to the inside of the liner 1.

Referring to FIGS. 1 and 2, in some implementations, the bead cutter 70 is configured to cut the welding bead 5 of the liner 1 that rotates by the liner mount 20.

The bead cutter 70 is installed on the jig frame 10 to be movable forward and backward in the left-right direction.

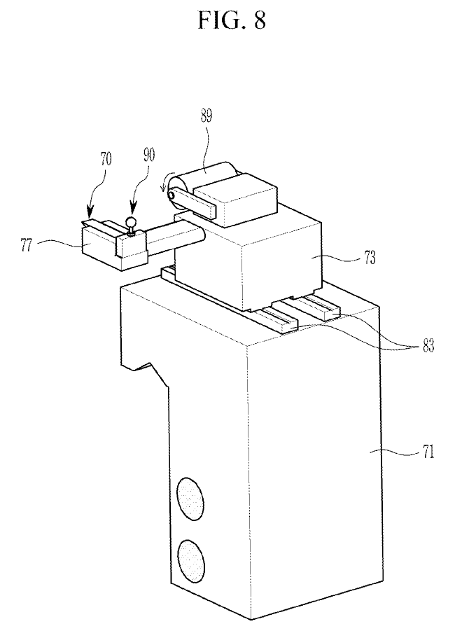

FIG. 8 is a view illustrating a mounting structure of a bead cutter applied to a device for machining a liner welding bead of a hydrogen tank.

Referring to FIGS. 1, 2, and 8, the device 100 includes a shuttle block 71 and a cutter support block 73.

The shuttle block 71 is installed on a jig frame 10 to be movable forward and backward in the front-rear direction. The shuttle block 71 can be reciprocated in the front-rear direction along at least one shuttle guide rail 79 mounted on the jig frame 10.

The shuttle block 71 can be reciprocated in the front-rear direction along at least one shuttle guide rail 79 by driving a shuttle driver 81. The shuttle driver 81 is operatively connected to the shuttle block 71.

The shuttle driver 81 can include, in an example, an actuator that converts a rotational motion of a servo motor into a linear motion through a power converter. In another example, the shuttle driver 81 can include an operating cylinder. In another example, the shuttle driver 81 can include a linear motor.

The cutter support block 73 is mounted on the shuttle block 71 to be movable forward and backward in the left-right direction. The cutter support block 73 can be reciprocated in the left-right direction along at least one cutter guide rail 83 mounted on the shuttle block 71.

The cutter support block 73 is coupled to the bead cutter 70 and can be reciprocated in the left-right direction along at least one cutter guide rail 83 by driving a cutter driver 75. The cutter driver 75 is operatively connected to the cutter support block 73.

The cutter driver 75 described above can include, in an example, an actuator that converts the rotational motion of the servo motor into a linear motion through a power converter. In another example, the cutter driver 75 can include an operating cylinder. In another example, the cutter driver 75 can include a linear motor.

In some examples, the bead cutter 70 described above can be fixed to a mounting block 77 coupled to the cutter support block 73.

Furthermore, a stopper roller 89 is rotatably installed on the cutter support block 73. The stopper roller 89 is configured to rotate in contact with the outer circumferential surface of the liner 1 when the bead cutter 70 moves forward. The stopper roller 89 can prevent the bead cutter 70 from moving forward beyond a set maximum forward range.

Referring to FIGS. 1 and 2, in some implementations, the reaction force detection sensor 90 is configured to detect reaction force applied to the bead cutter 70 when the bead cutter 70 moves forward and cuts the welding bead 5 of the liner 1.

The reaction force detection sensor 90 is coupled to the bead cutter 70, as shown in FIG. 8. The reaction force detection sensor 90 can be fixed to the mounting block 77 mentioned above and can be connected to the bead cutter 70.

The reaction force detection sensor 90 can include a load sensor, as an example. The configuration and operation of the load sensor are obvious to those skilled in the art, and thus a detailed description thereof will be omitted.

Referring to FIG. 2, in some implementations, the controller 99 is a controller that controls the overall operation of the device 100 configured as described above.

In some implementations, the controller 99 can be implemented as one or more control processors that operate according to a set program and can include a series of commands for performing the contents. The controller 99 can include an electric circuit.

In some examples, the controller 99 can control a forward-backward movement distance of the bead cutter 70 by applying a set driving control signal to the cutter driver 75 according to a detection signal of the reaction force detection sensor 90.

Furthermore, the controller 99 can control the valve opening amount of the air valve 65 according to a detection signal of the pressure sensor 63 as illustrated in FIG. 7.

The process of controlling the forward-backward movement distance of the bead cutter 70 and the valve opening amount of the air valve 65 using the controller 99 will be described in detail below.

Hereinafter, the operation of the device 100 configured as described above will be described in detail with reference to FIGS. 1 to 8.

In some implementations, the liner 1 manufactured by an injection molding process, a welding process, etc. is provided. The welding bead 5 is formed at a welding joint of the liner parts 3 in the liner 1. In addition, the liner 1 includes the front nozzle 7 and the rear nozzle 9 respectively provided on both sides in the longitudinal direction.

In some examples, the inner ring 41 of the liner outer support 40 is fitted and fixed to the outer circumferential surface of the liner 1 described above in the longitudinal direction of the liner 1. The inner ring 41 can be manufactured in different sizes depending on the outer diameter of the liner 1.

In some examples, the outer bracket 43 of the liner outer support 40 is fixed to the fixed rails 42 on the jig frame 10.

The second portion 49 of the outer bracket 43 is in an unlocked state with the first portion 47 and rotated in one direction, and the semicircle of the first portion 47 is in an open state. Also, the bearing rods 55 of the bearing members 45 of the liner outer support 40 are in a state of being moved backward.

In this state, the liner 1 is disposed in the semicircle of the first portion 47, and the front nozzle 7 of the liner 1 is chucked and coupled to the liner chucking portion 24 of the liner mount 20. In some examples, the liner docking portion 25 of the liner mount 20 is in a state of being moved backward by the driving of the docking driver 26.

Then, the liner docking portion 25 moves forward by the driving of the docking driver 26. Accordingly, the liner docking portion 25 is docked and coupled to the rear nozzle 9 of the liner 1.

In some examples, the inner ring 41 can be located in the semicircle of the first portion 47. However, if the inner ring 41 is not located in the semicircle of the first portion 47, the first portion 47 is separated from the fixed rails 42 by the release of the fastening member 44 and moves to a position corresponding to the inner ring 41. In this state, the first portion 47 is fixed to the fixed rails 42 by the fastening member 44.

In some examples, the second portion 49 of the outer bracket 43 is rotated in the other direction and locked to the first portion 47 by the locking member 53. Accordingly, the inner ring 41 is located in the semicircle of the second portion 49.

In some examples, the bearing rod 55 moves forward in a direction toward the outer circumferential surface of the inner ring 41. Since the bearing rod 55 is screw-coupled to the through-hole 56 of the outer bracket 43, when the bearing rod 55 rotates in one direction, the bearing rod 55 moves forward through the through-hole 56.

Therefore, the balls 57 of the bearing members 45 come into rolling contact with the ball race 59 of the inner ring 41, and the bearing rod 55 supports the outer circumferential surface of the inner ring 41 through the balls 57.

In some examples, the shuttle block 71 is located at a position corresponding to the welding bead 5 of the liner 1, while moving forward and backward along at least one shuttle guide rail 79 by the driving of the shuttle driver 81.

In some examples, the cutter support block 73 is in a state of moving backward in the left-right direction through at least one cutter guide rail 83 by the driving of the cutter driver 75.

Accordingly, the bead cutter 70 fixed to the mounting block 77 is maintained in a state of being separated from the welding bead 5 due to the backward movement of the cutter support block 73. In addition, the stopper roller 89 mounted on the cutter support block 73 is maintained in a state of being separated from the outer circumferential surface of the liner 1.

In the state described above, the liner chucking portion 24 rotates by the driving of the rotational driver 23. Accordingly, since the front nozzle 7 of the liner 1 is chucked and coupled to the liner chucking portion 24 and the rear nozzle 9 is docked and coupled to the liner docking portion 25, the liner 1 is rotated by the liner chucking portion 24.

In this process, the air blower 61 of the liner inner support 60 injects air into the inside of the liner 1 through the front nozzle 7 of the liner 1. Then, air pressure is applied to the inside of the liner 1, and the air pressure is applied to the inner circumferential surface of the liner 1.

In some examples, in a state in which the liner 1 rotates, the cutter support block 73 moves forward along at least one cutter guide rail 83 by the driving of the cutter driver 75.

Accordingly, the bead cutter 70 moves forward at a position corresponding to the welding bead 5, and the stopper roller 89 moves forward at a position corresponding to the outer surface of the liner 1.

Then, the bead cutter 70 cuts the welding bead 5 of the liner 1, while moving forward.

In some examples, the controller 99 applies, for example, a pulse control signal to the cutter driver 75. Accordingly, the bead cutter 70 moves forward in stages by 0.2 mm each time, in an example, by the pulse driving of the cutter driver 75.

As described above, during the process of cutting the welding bead 5, the liner 1 rotates, while the ball 57 is in rolling contact with the ball race 59 of the inner ring 41, and thus, the inner ring 41 does not escape from the outer bracket 43 by the ball 57. In addition, since the inner ring 41 supports and regulates the outer circumferential surface of the liner 1, an external shaking phenomenon of the liner 1 can be prevented.

In addition, since the inner circumferential surface of the liner 1 is supported and regulated by the pressure of the air supplied from the air blower 61 as described above, the internal shaking phenomenon of the liner 1 can be prevented.

In this manner, since the liner outer support 40 and the liner inner support 60 simultaneously support and regulate the outer and inner circumferential surfaces of the liner 1 as described above, a deviation of the out of roundness of the liner 1 can be minimized and positional stability and rotational stability of the liner 1 can be improved.

In some examples, when the bead cutter 70 moves to the maximum forward movement distance input to the controller 99, a stop signal is applied to the cutter driver 75 by the controller 99. Accordingly, the forward movement of the cutter support block 73 is stopped, and the cutting process of the welding bead 5 is completed.

In some examples, the stopper roller 89 rotates in contact with the outer circumferential surface of the liner 1. Accordingly, the stopper roller 89 can prevent the bead cutter 70 from moving forward more than the maximum forward movement distance.

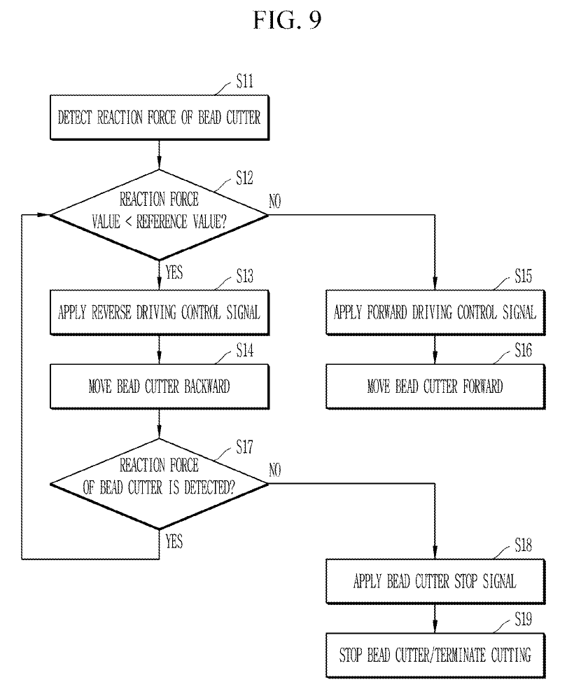

In some examples, in the process of cutting the welding bead 5 as described above, as shown in FIGS. 2 and 9, the reaction force detection sensor 90 detects reaction force applied to the bead cutter 70 and outputs a detection signal to the controller 99 (S11).

Therefore, the controller 99 determines whether a reaction force value of the bead cutter 70 obtained from the reaction force detection sensor 90 exceeds a set reference value (for example, 120 kPa) (S12).

If it is determined that the reaction force value of the bead cutter 70 exceeds the reference value in process S12, the controller 99 applies a reverse driving control signal to the cutter driver 75 (S13).

In some examples, when cutting the welding bead 5, the reaction force value applied to the bead cutter 70 can exceed the reference value due to a step and out-of-roundness deviation of the welding bead 5 and the occurrence of vibration of the bead cutter 70.

For example, if the cutting amount of the welding bead 5 exceeds 0.5 mm depending on the welding state of the welding bead 5 and the rotation state of the liner 1 as described above, reaction force of 120 kPa or more can be applied to the bead cutter 70.

In this case, the bead cutter 70 moves backward with a stroke of, for example, 0.5 mm by the reverse driving of the cutter driver 75 that has obtained the reverse driving control signal from the controller 99 (S14).

Also, if it is determined that the reaction force value of the bead cutter 70 does not exceed the reference value in process S12, the controller 99 applies a forward driving control signal to the cutter driver 75 (S15).

Therefore, the bead cutter 70 moves forward with a stroke of, for example, 0.2 mm by the forward driving of the cutter driver 75 that has obtained the forward driving control signal from the controller 99 (S16).

Furthermore, the controller 99 determines whether reaction force of the bead cutter 70 is detected by the reaction force detection sensor 90 (S17).

If it is determined that the reaction force of the bead cutter 70 is detected by the reaction force detection sensor 90 in process S17, the controller 99 repeats the process S12.

Also, if it is determined that the reaction force of the bead cutter 70 is not detected by the reaction force detection sensor 90 in process S17, the controller 99 applies a stop signal to the cutter driver 75 (S18).

Accordingly, the forward movement of the cutter support block 73 is stopped, and the cutting processing of the welding bead 5 is terminated when the bead cutter 70 reaches the maximum forward movement distance (S19).

Therefore, when cutting the welding bead 5, the welding bead 5 can be prevented from being cut excessively by the bead cutter 70 beyond the set cutting amount, depending on the welding state of the welding bead 5 and the rotation state of the liner 1.

In some examples, as described above, during the process of cutting the welding bead 5, air is injected into the inside of the liner 1 by the air blower 61.

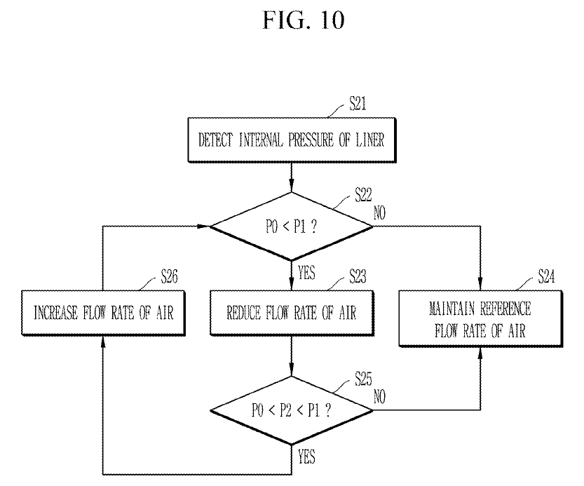

In some examples, the air valve 65 is opened by the reference opening amount OP to supply air of the set reference flow rate into the inside of the liner 1. Then, as shown in FIGS. 7 and 10, the pressure sensor 63 detects the internal pressure of the liner 1 and outputs a detection signal to the controller 99 (S21).

Therefore, the controller 99 determines whether an internal pressure value P0 of the liner 1 obtained from the pressure sensor 63 exceeds a set first reference value P1 (for example, 3 to 4 bar) (S22).

If it is determined that the internal pressure value P0 exceeds the first reference value P1 in process S22, the controller 99 applies a first control signal corresponding to the first opening amount OP1 smaller than the reference opening amount OP of the air valve 65 to the air valve 65.

Then, the air valve 65 is opened by the first opening amount OP1 smaller than the reference opening amount OP to supply air of a flow rate smaller than the reference flow rate to the inside of the liner 1 (S23).

In addition, if it is determined that the internal pressure value P0 satisfies the first reference value P1 in process S22, the controller 99 applies a second control signal corresponding to the reference opening amount OP of the air valve 65 to the air valve 65.

Accordingly, the air valve 65 is opened by the reference opening amount OP to supply air of the reference flow rate to the inside of the liner 1 (S24).

In this process, the controller 99 determines whether the internal pressure value P0 is less than the second reference value P2 (e.g., 3 bar) that is smaller than the first reference value P1 (S25).

If it is determined that the internal pressure value P0 is less than the second reference value P2 that is smaller than the first reference value P1 in process S25, a third control signal corresponding to the second opening amount OP2 that is larger than the reference opening amount OP of the air valve 65 is applied to the air valve 65.

Then, the air valve 65 is opened by the second opening amount OP2 that is larger than the reference opening amount OP to supply air at a flow rate larger than the reference flow rate to the inside of the liner 1 (S26).

Also, if it is determined that the internal pressure value P0 is not less than the second reference value P2 that is smaller than the first reference value P1 in process S25, a fourth control signal corresponding to the reference opening amount OP of the air valve 65 is applied to the air valve 65. Accordingly, the air valve 65 is opened by the reference opening amount OP and supplies air of the reference flow rate to the inside of the liner 1 as in process S24.

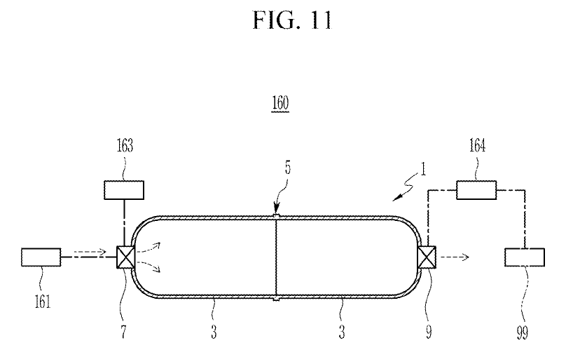

FIG. 11 is a drawing illustrating an example of a liner inner support applied to a device for machining a liner welding bead of a hydrogen tank.

Referring to FIG. 11, the liner inner support 160 according to the modified example includes an air blower 161, a pressure sensor 163, and a solenoid valve 164.

The configuration and operation of the air blower 161 and pressure sensor 163 are the same as described above, so detailed descriptions are omitted.

In addition, the solenoid valve 164 is installed in the rear nozzle 9 of the liner 1. The solenoid valve 164 can be opened and closed by a control signal applied from the controller 99.

Therefore, if it is determined that the internal pressure value of the liner 1 obtained from the pressure sensor 163 does not exceed the set reference value (for example, 3 to 4 bars), the controller 99 applies a closing signal to the solenoid valve 164.

In addition, if it is determined that the internal pressure value of the liner 1 obtained from the pressure sensor 163 exceeds the set reference value, the controller 99 applies an opening signal to the solenoid valve 164. Accordingly, the air injected into the inside of the liner 1 can be discharged through the rear nozzle 9.

The device 100 as described so far can automatically move the bead cutter 70 forward and backward according to a reaction force value applied to the bead cutter 70 when cutting the welding bead 5 by the bead cutter 70.

Therefore, the device 100 can minimize a cutting deviation of the welding bead 5 according to the welding state of the liner 1, the rotation state of the liner 1, and the forward movement distance of the bead cutter 70, thereby reducing a welding defect of the liner 1.

In addition, since the device 100 can cut the welding bead 5 of the liner 1 of various specifications having different outer diameters, the productivity of the hydrogen tank can be improved and the manufacturing cost of the processing equipment can be reduced.

Furthermore, according to the device 100, the liner outer support 40 and the liner inner supports 60 and 160 can simultaneously support and regulate the outer and inner circumferential surfaces of the liner 1, so the positional stability and rotational stability of the liner 1 can be improved.

While this disclosure has been described in connection with what is presently considered to be practical exemplary implementations, it is to be understood that the disclosure is not limited to the disclosed exemplary implementations. On the contrary, it is intended to cover various modifications and equivalent arrangements included within the spirit and scope of the appended claims.

What is claimed is:

1. A device for machining a hydrogen tank, the device being configured to cut a welding bead disposed at a liner of the hydrogen tank, the device comprising:
a jig frame;
a liner mount disposed at the jig frame and configured to rotatably support the liner and to apply a rotational force to the liner;
a liner outer support disposed at the jig frame and configured to support an outer circumferential surface of the liner;
a bead cutter disposed at the jig frame and configured to move forward and backward along the liner and to cut the welding bead;
a cutter driver configured to move the bead cutter forward and backward along the liner;
a reaction force detection sensor coupled to the bead cutter and configured to detect a reaction force applied to the bead cutter; and
a controller configured to control a forward-backward movement distance of the bead cutter based on applying, the cutter driver, a set driving control signal according to a detection signal of the reaction force detection sensor.

2. The device of claim 1, further comprising:
a liner inner support disposed at the liner mount and configured to support an inner circumferential surface of the liner by injecting air at a set pressure into an inside of the liner.

3. The device of claim 1, wherein the liner mount comprises:
a main mounting portion disposed at a front portion of the jig frame and configured to support a front nozzle provided at a first side of the liner;
a sub-mounting portion disposed at a rear of the jig frame and configured to support a rear nozzle provided at a second side of the liner;
a rotational driver disposed at the main mounting portion and configured to apply the rotational force to the liner;
a liner chucking portion connected to the rotational driver and rotatably disposed at the main mounting portion and configured to be coupled to the front nozzle;
a liner docking portion disposed at the sub-mounting portion and configured to move in a front-rear direction relative to the rear of the jig frame to thereby support the rear nozzle; and
a docking driver configured to move the liner docking portion in the front-rear direction relative to the rear of the jig frame.

4. The device of claim 1, wherein the liner outer support comprises:
an inner ring configured to surround the outer circumferential surface of the liner and to rotate with the liner;
an outer bracket fixed to a set position of the jig frame, wherein the inner ring is disposed at an inner side of the outer bracket; and
a plurality of bearing members disposed at the outer bracket and configured to support the inner ring.

5. The device of claim 4, wherein each of the plurality of bearing members comprises:
a bearing rod movably coupled to the outer bracket and configured to move toward and away from an outer circumferential surface of the inner ring; and
a ball rotatably disposed at the bearing rod and configured be in contact with the outer circumferential surface of the inner ring based on rotation of the liner.

6. The device of claim 5, wherein the inner ring comprises a ball race that is a groove defined along the outer circumferential surface of the inner ring and configured to contact with the balls.

7. The device of claim 5, wherein the outer bracket comprises:
a first portion fixed to the jig frame; and
a second portion hingedly connected to the first portion through a hinge pin.

8. The device of claim 1, further comprising:
a shuttle block disposed at the jig frame and configured to move in a front-rear direction;
a shuttle driver configured to move the shuttle block in the front-rear direction; and
a cutter support block disposed at the shuttle block and coupled to the bead cutter, the cutter support block being configured to move, by the cutter driver, in a left-right direction transverse to the front-rear direction.

9. The device of claim 8, further comprising:
a stopper roller rotatably disposed at the cutter support block and configured to rotate based on being in contact with the outer circumferential surface of the liner.

10. The device of claim 8, further comprising a mounting block coupled to the cutter support block,
wherein the bead cutter is fixed to the mounting block, and
wherein the reaction force detection sensor is fixed to the mounting block and coupled to the bead cutter.

11. The device of claim 2, wherein the liner inner support comprises an air blower configured to supply air at the set pressure to the inside of the liner through a front nozzle disposed at a first side of the liner.

12. The device of claim 11, wherein the liner inner support further comprises a pressure sensor configured to detect an internal pressure of the liner and to output a detection signal to the controller.

13. The device of claim 12, wherein the liner inner support further comprises an air valve, and
wherein the controller is configured to control a valve opening amount of the air valve based on the detection signal of the pressure sensor.

14. The device of claim 1, wherein the controller is configured to:
determine whether a reaction force value of the bead cutter obtained from the reaction force detection sensor exceeds a set reference value; and
apply a reverse driving control signal to the cutter driver based on determining that the reaction force value of the bead cutter exceeds the set reference value.

15. The device of claim 14, wherein the controller is configured to apply a forward driving control signal to the cutter driver based on determining that the reaction force value of the bead cutter is less than or equal to the set reference value.

16. The device of claim 13, wherein the controller is configured to adjust the valve opening amount of the air valve based on an internal pressure value of the liner obtained from the pressure sensor.

17. The device of claim 12, wherein the liner inner support further comprises a solenoid valve configured to disposed at a rear nozzle of the liner, the rear nozzle being disposed at a second side of the liner, and
wherein the controller is configured to open and close the solenoid valve based on an internal pressure value of the liner obtained from the pressure sensor.

18. The device of claim 1, wherein the cutter driver comprises at least one or a motor, a power converter, an actuator, or an operating cylinder.

19. The device of claim 1, wherein the cutter driver comprises a linear motor.
